(19) United States
(12) Patent Application Publication
(10) Pub. No.: US 2012/0290637 A1
(43) Pub. Date: Nov. 15, 2012

(54) PERSONALIZED NEWS FEED BASED ON PEER AND PERSONAL ACTIVITY

(75) Inventors: GEORGE PERANTATOS, Seattle, WA (US); John Wana, Seattle, WA (US); Ilya Tumanov, Remond, WA (US); Brian R. Meyers, Issaquah, WA (US)

(73) Assignee: MICROSOFT CORPORATION, REDMOND, WA (US)

(21) Appl. No.: 13/106,149

(22) Filed: May 12, 2011

(51) Int. Cl. G06F 15/16

(52) U.S. Cl. 709/203

(57) ABSTRACT

Systems, methods and computer program products for providing a customized news feed to an individual computer user within an organization based on the reading activities and preferences of other users in the same organization are disclosed. In an embodiment, the system includes a correlation server configured to collect and correlate the reading activities and preferences of individual computer network users within the organization, a news feed database for storing the collected and correlated data, a proxy server configured to receive and output to the information client a selected portion of the collected and correlated data, and a graphical user interface produced by the proxy server that allows the user to select different views of the collected and correlated data as a personalized news feed.

### CROSS REFERENCE TO RELATED APPLICATIONS

This Application is related to co-pending: U.S. patent application Ser. No. 12/773,319 (Attorney Docket No. 329299.01), titled “Presentation of Information Describing User Activities With Regards To Resources,” filed on May 4, 2010; U.S. patent application Ser. No. 12/771,290 (Attorney Docket No. 329298.01), titled “Prioritization of Resources Based On User Activities,” filed on April 30, 2010; U.S. patent application Ser. No. TBD (Attorney Docket No. 332176.01), titled “Automatic Social Graph Calculation,” filed concurrently herewith; and U.S. Patent Application No. TBD (Attorney Docket No. 332178.01), titled “Collection of Intranet Activity Data,” filed concurrently herewith; each of which is hereby incorporated by reference as to its entire contents.

### FIELD OF THE INVENTION

The present invention generally relates to computer networks and more particularly to systems, methods and computer program products for providing a news feed within such networks.

### BACKGROUND

Workers, in an information-based service organization for example, may expend a significant portion of their daily activities and functions searching for and digesting news related to the business of their organization. If the organization includes software professionals, for example, the news of most interest may be articles and stories related to competitors in the software industry, software industry trends, and new press releases related to the organization itself, and would not include stories and articles related to, for example, automotive topics. An extensive amount of such relevant data may be found via Internet searching, but reviewing this sheer volume of data may present a formidable problem to the individuals within the organization. In addition, the individual often has to wade through articles they have already read to get to new articles because a browser does not keep track of, and hide, articles that have been fully read in the past.

As an alternative, an individual worker or the organization may subscribe to online newspapers and blogs that provide editorialized content, but even this approach may result in a stream of information that requires more time for review than the worker is willing (or able) to invest. The worker can search through editorialized content by providing a proper query in order to retrieve the information most relevant to the needs of the organization. However, unless the query is submitted in an optimal format, the individual has no way of knowing whether the search results are accurate or comprehensive. Moreover, if the individual has no prior knowledge about a potential competitor or product, for example, keywords related to the potential competitor or product may not be used in the query, and information about the potential competitor or product will most likely not appear in the search results.

To address this problem, the organization may hire a part-time or full-time editorial staff to produce an internal newsletter or information bulletin. However, apart from the additional cost incurred by the organization to fund the editorial staff, the resulting publication may still offer articles that are of little interest to an individual, or may offer articles that most of the individuals within the organization have already read. Accordingly, such an editorial staff may provide limited benefits to the organization, without fully meeting the information needs of the individuals within the organization.

Given the foregoing, what is needed are systems, methods and computer program products for providing a news feed that is narrowly directed to the needs of an individuals within an organization.

### SUMMARY

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present invention meets the above-identified needs by providing systems, methods and computer program products for using the online information-gathering activities of computer users within an organization to define customized (i.e., personalized based on past reading and/or socially “near” individuals) news feeds (i.e., articles published on the Internet) for an individual within the organization.

In an embodiment, a system for providing a customized news feed to an information client based on the reading activities and preferences of other information clients in the same organization is disclosed. The system includes a correlation server that collects and correlates the reading activities and preferences of information clients in the organization, a news feed database to store the collected and correlated data, and a proxy server configured to receive and output to the information client a selected portion of the collected and correlated data in the form of a personalized news feed for that individual.

In another embodiment, a computer-implemented method for providing a customized news feed to an information client based on the reading activities and preferences of other information clients in the same organization is disclosed. The method includes collecting reading habits of information clients in the organization, and correlating the reading habits so as to identify a group of information clients having similar reading habits. Next, news source URLs accessed by the group of information clients having similar reading habits are identified, news articles from such URLs are collected, and an administration filter is applied to obtain news articles. Lastly, the administratively filtered news articles are provided to the information client as a customized news feed.

Further features and advantages of the present invention, as well as the structure and operation of various embodiments of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a block diagram illustrating an exemplary customized news feed system, according to an embodiment of the present invention.

FIG. 2 is a functional block diagram showing inputs to a news reading activity database in the customized news feed system of FIG. 1, according to an embodiment of the present invention.

FIG. 3 is a flowchart illustrating operation of the customized news feed system of FIG. 1, according to an embodiment of the present invention.

FIG. 4 is a screenshot illustrating an exemplary personalized news feed output from the customized news feed system of FIG. 1, according to an embodiment of the present invention.

FIG. 5 is a functional block diagram of an exemplary computer system suitable for use in implementing the present invention.

### DETAILED DESCRIPTION

The present invention is directed to systems, methods, and computer program products for using the online information-gathering activities of computer users within an organization (e.g., students/faculty/staff within a university, co-workers within a company/business enterprise or local, state or federal government department or agency, co-workers within a charitable or any other type of organization) to define a customized news feeds. News articles and blogs that are widely accessed within the organization receive a relatively higher ranking within the customized news feed. Similarly, less popular articles and blogs may be given a relatively lower ranking or filtered out of the news feed delivered to the organization's computer network users. The reading habits of closely-associated workers remain anonymous within the customized news feed system, and may be used to influence the selection of news articles and blogs delivered to certain workers. In addition, the customized news provided to the workers may be selectively filtered to exclude sensitive websites, such as career or medical advice websites. In various embodiments, the customized news may be further filtered to allow only websites approved or deemed to be “safe” by a network administrator, such as a national newspaper website or technology news website.

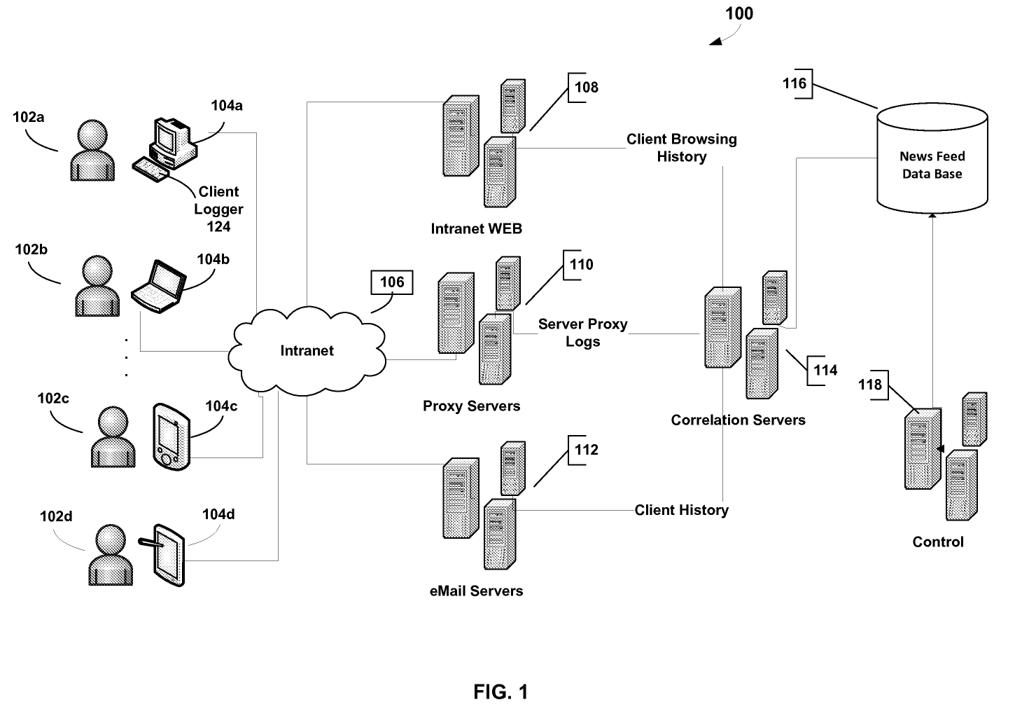

Referring to FIG. 1, a block diagram illustrating an exemplary customized news feed system 100, according to an embodiment of the present invention, is shown. Customized news feed system 100 includes a plurality of individual users (or information clients) 102 (shown as information clients 102a-d in FIG. 1) accessing, via a computing device 104 (shown as respective computing devices 104a-d in FIG. 1), an organization's intranet (i.e., a private network) 106. In various embodiments, computing device 104 may be configured as a desktop computer 104a, a laptop computer 104b, a personal digital assistant (PDA) 104c, a tablet or mobile computer 104d, any commercially-available intelligent communications device, or the like.

As will be appreciated by those skilled in the relevant art(s) after reading the description herein, intranet 106 may comprise a private network deployed by an organization such as a business enterprise for use by its employees, deployed by a university for use by its students and faculty, deployed by a government agency for its workers, and/or the like. As will also be appreciated by those skilled in the relevant art(s) after reading the description herein, customized news feed system 100 may be deployed across one or more jurisdictions as, for example, a multinational business enterprise makes its intranet 106 available to its employees around the world. This may subject customized news feed system 100 to a plurality of national, state and/or local privacy laws and regulations that are applicable in such one or more jurisdictions in which intranet 106 spans.

Information clients 102 may log into intranet 106, via respective computing devices 104, to navigate to URLs on the global, public Internet, to review various internal/external news articles, social networking posts and blogs, to read and send email and/or instant messages, and the like (all via, for example, one or more proxy servers 110). Customized news feed system 100 thus further includes one or more correlation servers 114 which perform the importing and processing of raw (client 102) information data from various sources within customized news feed system 100. In an embodiment, such sources of raw information data include log files from one or more proxy servers 110, one or more email servers 112 (e.g., individuals emailing links to news articles), one or more intranet web servers 108, and the like.

In alternate embodiments, other sources of raw information data within system 100 may include directory service information, web content management log files, document management log files (e.g., high business impact, web server log files, proxy server log files, email distribution lists or news groups, instant messages, text messages, telephone calls, and the like).

In an alternative embodiment of the present invention, each collection server 114 can host one or more activity data collection rules (or “adapters”) which are designed to retrieve data from a specific data source (e.g., web server 108, proxy server 110, email server 110, and/or the like).

In an embodiment, customized news feed system 100 includes one or more control servers 118 that are used to for configuration, and status and information data retrieval control of information flowing into customized news feed system 100 from external information sources, such as the Internet. That is, control servers 118 monitor the collection of information data as well as allow the information data to be consumed for the provisioning of high-value services as permitted by any applicable privacy laws and organizational rules. In an alternate embodiment, control servers 118 may employ a web interface (e.g., the SHAREPOINT® web platform available from Microsoft Corporation of Redmond, Wash.) to allow intranet administrators to configure and monitor the personalized news feeds.

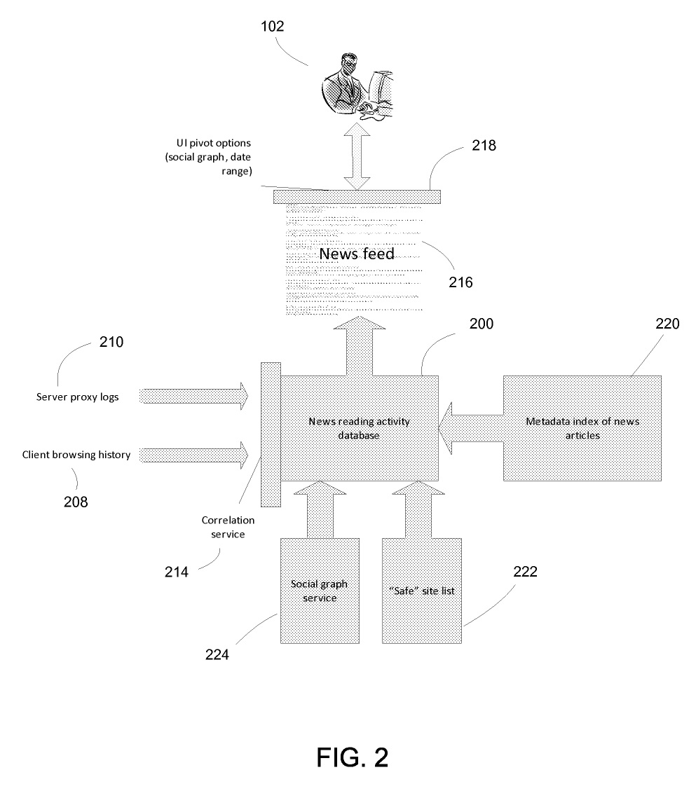

Referring to FIG. 2, a functional block diagram illustrating operation of customized news feed system 100, according to an embodiment of the present invention, is shown. A news reading activity database 200, resident in news feed database 116, includes a collection of information client activity that may be obtained as client browsing history 208 from intranet web servers 108, and as server proxy logs 210 from proxy servers 110. That is, client-side browsing history may be used to provide the information client activity. In an embodiment, this reading and browsing activity for information client 102a may be obtained by installing—consistent with privacy laws, organizational privacy policies, opt-in/out preferences, etc.—a client logger 124 in desktop computer 104a to provide this raw data for subsequent storage in news reading activity database 200.

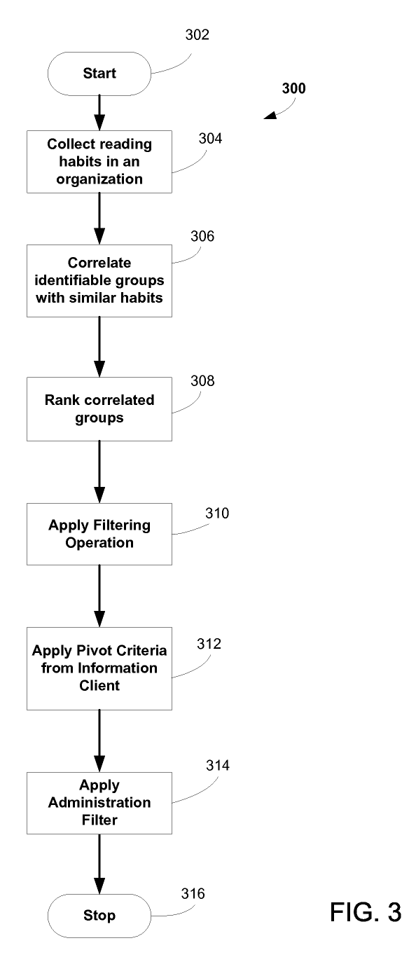

Referring to FIG. 3, a flow diagram 300 describing operation of customized news feed system 100, according to an embodiment of the present invention, is shown. Flow diagram begins at step 302 and proceeds immediately to step 304. In step 304, the above-described raw data is first obtained. In an embodiment, the collected data is then normalized. For example, different information client 102 may access the same news article from different devices or proxy log servers. All these cases might result in different URLs, while they all represent the Internet news article. Thus, they should all normalize down to a canonical URL form. In such a case, raw activity data would be collected by process 300 based on the content of the news article as opposed to being based on the original URL.

A correlation service module 214 functions to perform post-processing and analysis of the raw data, at step 306. This post-processing activity includes the correlation of data with respect to specifying which of the information clients 102 is accessing a particular uniform resource locator (URL) address, or the number of visits each information client 102 makes to a particular URL within a predetermined period of time. In addition, metadata 220 resident in the particular URL being browsed may be acquired for the task of rendering browsing summaries to news reading activity database 200. In an exemplary embodiment, metadata 200 may be obtained via reliance on an external (Internet) search engine (e.g., the Bing™ search engine available from Microsoft Corporation of Redmond, Wash.) that may already include such metadata information in its index. That is, in an embodiment, such indexes are used to expand a news URL into a Title, Description, Summary Image, and Caption to populate a personalized news feed so that it is more than just a list of URLs with no metadata.

When information client 102 accesses a personalized news feed 216, in an embodiment, customized news feed system 100 fetches a social graph that may be provided for information client 102 by a social graph service 224 (i.e., a service that calculates the personal social network of a user 102). The social graph may be sourced from activity information client 102 has declared, or by identifying common distribution list memberships, physical proximities, working associates, business unit commonalities, friends lists on social networking websites, organizational charts, and/or the like, all relative to other users (i.e., associates of client 102) within intranet 106. Once the social graph has been obtained, customized news feed system 100 may create a set of news links accessed by information clients 102 listed in the social graph, and rank the news links using one or more predetermined factors. The reading habits of an identified number of groups of information clients 102, for example, may be correlated, at step 308, such as by correlating those information clients 102 that read the same news article(s) or web page(s) on the same date.

A particular URL may be given a higher ranking in the set of news links if the particular URL has been accessed a greater number of times compared to other URLs in the set of news links. A higher frequency of access for the particular URL will also increase its ranking, in accordance with a filtering operation at step 310. In an exemplary embodiment, access activity involving reading the corresponding web page merits a higher ranking compared to access activity involving a cut-and-paste action. Saving the particular URL visited as a “favorite” (or bookmarking it) may also increase the ranking of the URL.

In an embodiment, another factor considered by customized news feed system 100 is whether information client 102, using computing device 104, had previously accessed a particular URL (i.e., information client 102 has already read a particular news article using any device 104), and whether information client 102 remained at the website, read for several minutes, and/or saved it as a favorite (i.e., bookmarked the website). Once news feed 216 is generated by customized news feed system 100, information client 102 may further filter the results in news feed 216 by using pivot (i.e., viewing) options 218, at step 312. Pivot options allow the individual information client 102 to present news feed 216 based on, for example, social groups such as team, discipline, friends, workgroups, and/or the entire organization. This action may change the social graph in social graph service 224 used by customized news feed system 100 to produce news feed 216. Alternatively, information client 102 may filter the results by changing a date range used to produce news feed 216, or by including or excluding news items previously viewed by information client 102.

In an alternative embodiment, customized news feed system 100 may crawl the plurality of URLs visited by information clients 102, using respective computing devices 104, for acquisition of the title, description and summary metadata for respective URLs. If desired, the administrator of customized news feed system 100 can manage the URL information such that only “safe” or filtered information is made available to news reading activity database 200, at step 314. The Internet website links may also be filtered such that only sites (and/or subsites) preapproved by an administrator are included in a safe website list 222 to be used as news feeds provided to news reading activity database 200. For example, while a New York Times website may be specified as an approved site, a website such as the WebMD® medical advice website, that includes medical information, may not be specified as a preapproved link. For example, access to the WebMD website by information client 102 may result in privacy concerns for users of customized news feed system 100. Process 300 then terminates as indicated by step 316.

As will be appreciated by those skilled in the relevant art(s) after reading the description herein, in various embodiments, steps 304-308 may be repeated according to one or more pre-determined criteria based upon the requirements of customized news feed system 100. In addition, information client 102 may be given the option of accessing a “refresh” button to update the displayed articles and news pages.

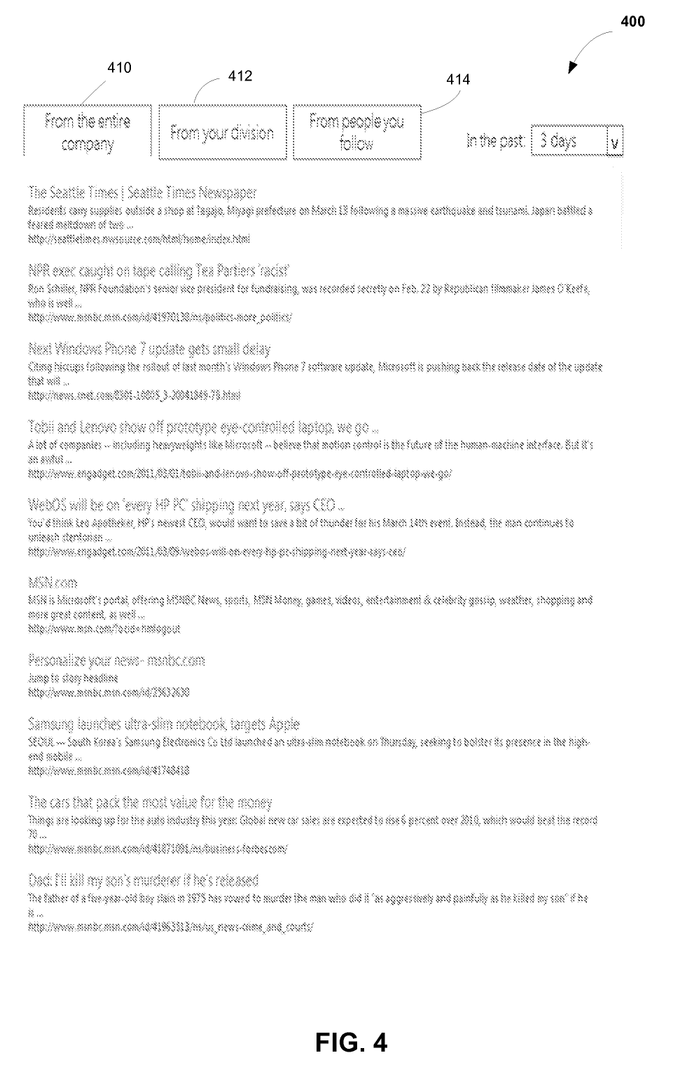

Referring to FIG. 4, an exemplary personalized news feed graphical user interface screen 400, as may be provided to information client 102 as an output from pivot (i.e., viewing) options 218 in an embodiment of the present invention, is shown. Personalized news feed 400 includes a first tab 410 that information client 102, using respective computing devices 104, may select to list frequently-viewed news stories in the organization as a whole. Likewise, information client 102 may select a second tab 412 to access news stories most often viewed by fellow employees in his division or business unit, or a third tab 414 to see the viewing habits of persons followed/friended/linked by information client 102 on one or more sites. In an alternate embodiment, information client 102 may “train” system 100, for example, by using a “vote up” or “vote down” button for certain articles and thus guide what system 100 presents to them next on screen 400. In such an embodiment, selecting such voting buttons may change the weights for utilizing the social graph or boost or reduce weightings for news article topics, sources or keywords.

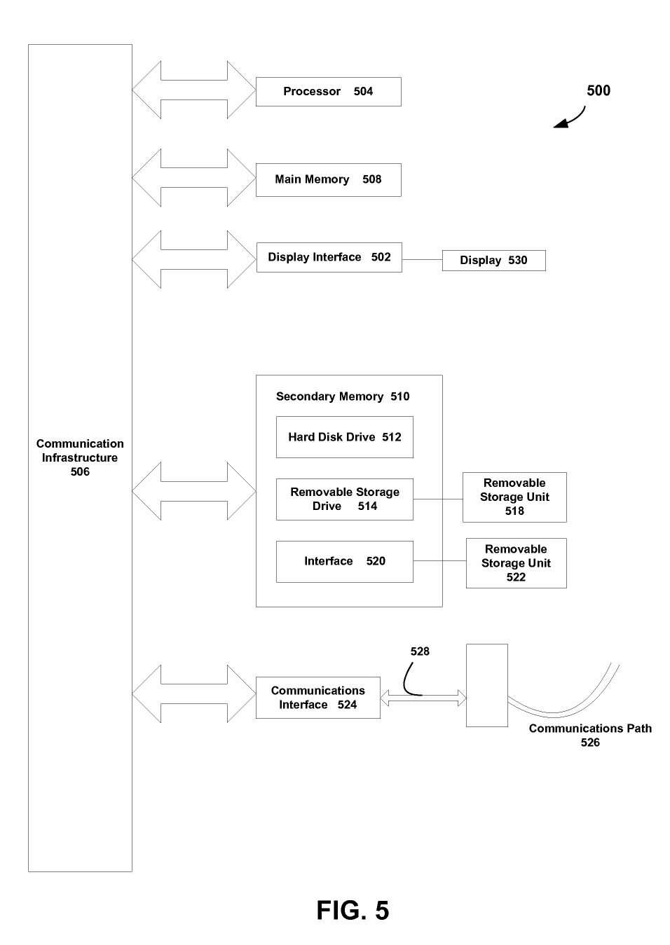

In one embodiment, customized news feed system 100 may be directed toward one or more computer systems capable of carrying out the functionality described herein. An example of a computer system 500 is shown in FIG. 5. Computer system 500 includes one or more processors, such as processor 504. Processor 504 may be connected to a communication infrastructure 506, such as a communications bus or network, for example. Various software aspects are described in terms of this exemplary computer system. After reading this description, it will become apparent to a person skilled in the relevant art(s) how to implement the invention using other computer systems and/or architectures.

Computer system 500 can include a display interface 502 that forwards graphics, text and other data from communication infrastructure 506, or from a frame buffer (not shown), for display via display unit 530. Computer system 500 may also include a main memory 508, preferably a random access memory (RAM), and may further include a secondary memory 510. Secondary memory 510 may include, for example, a hard disk drive 512 and/or a removable storage drive 514, representing a floppy disk drive, a magnetic tape drive, or an optical disk drive, for example. Removable storage drive 514 reads from and/or writes to a removable storage unit 518 in a manner well known in the relevant art. Removable storage unit 518 represents a floppy disk, magnetic tape, or an optical disk, which is read by and written to by removable storage drive 514. As can be appreciated, removable storage unit 518 includes a computer usable storage medium having stored therein computer software and/or data.

In alternative aspects, secondary memory 510 may include other similar devices for allowing computer programs or other instructions to be loaded into computer system 500. Such devices may include, for example, a removable storage unit 522 and an interface 520. Examples of such may include a program cartridge and cartridge interface, such as may be found in video game devices, a removable memory chip, such as an erasable programmable read only memory (EPROM), or programmable read only memory (PROM), and associated socket and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of a communications interface 524 may include a modem, a network interface such as an Ethernet card, a communications port, and a Personal Computer Memory Card International Association (PCMCIA) slot and card. Software and data transferred via communications interface 524 are in the form of non-transitory signals 528 which may be electronic, electromagnetic, optical or other signals capable of being received by communications interface 524. Signals 528 may be provided to communications interface 524 via a communications path or channel 526. Channel 526 may carry signals 528 and may be implemented using wire or cable, fiber optics, a telephone line, a cellular link, a radio frequency (RF) link, and other communications channels.

In this document, the terms “computer program medium” and “computer usable medium” are used to generally refer to media such as removable storage drive 514, a hard disk installed in hard disk drive 512, and signals 528. These computer program products provide software to computer system 500, wherein the present invention is directed to such computer program products.

Computer programs (also referred to as computer control logic), may be stored in main memory 508 and/or secondary memory 510. Computer programs may also be received via communications interface 524. Such computer programs, when executed, enable computer system 500 to perform the features of the present invention, as discussed herein. In particular, the computer programs, when executed, enable processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512 or communications interface 524. The control logic (software), when executed by processor 504, causes processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

As will be apparent to one skilled in the relevant art(s) after reading the description herein, the computer architecture shown in FIG. 5 may be configured as a desktop, a laptop, a server, a tablet computer, a PDA, a mobile computer, an intelligent communications device or the like. In yet another embodiment, the invention may be implemented using a combination of both hardware and software.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A system for providing a customized news feed to an information client based on the reading activities and preferences of other information clients within the same organization, comprising:
(a) a correlation server configured to collect and correlate data related to the reading activities and preferences of a plurality of other information clients within the organization;
(b) a news feed database, coupled to said correlation server, capable of storing said collected and correlated data;
(c) a proxy server, coupled to said correlation server, configured to receive and output to the information client a selected portion of said collected and correlated data; and
(d) a graphical user interface, produced by said proxy server, configured to allow the information client to pivot said selected portion of said collected and correlated data.

2. The system of claim 1, further comprising:
(e) a client logger executing on a computing device utilized by the information client and configured to collect data related to the reading activities and preferences of the information client.

3. The system of claim 2, wherein said selected portion of said collected and correlated data outputted by said proxy server includes at least a portion of said data related to the reading activities and preferences of the information client collected by said client logger.

4. The system of claim 1, further comprising:
(e) a control server configured to control information flowing into said system from external information sources.

5. The system of claim 1, wherein said news feed database comprises a news reading activity database for receiving information client browsing data from at least one of an email server, a web server and a proxy server, coupled to said correlation server.

6. The system of claim 5, further comprising:
(e) a social graph service coupled to said news reading activity database, said social graph service functioning to identify at least one associate of the information client from among the plurality of other information clients and to provide to the information client news links to websites accessed by said at least one associate.

7. The system of claim 5, wherein said news reading activity database comprises a safe website list of internet links preapproved by an administrator of said system.

8. The system of claim 5, wherein said news reading activity database comprises metadata acquired from websites browsed by the information client.

9. A computer-implemented method for providing a customized news feed to an information client, the news feed based on the reading activities and preferences of other information clients within the same organization, comprising the steps of:
(a) collecting data related to the reading habits of a plurality of other information clients in the organization;
(b) correlating said data so as to identify a group among said plurality of other information clients having similar reading habits;
(c) identifying news source URLs accessed by said group;
(d) obtaining news articles from said news source URLs;
(e) applying an administration filter to said obtained news articles; and
(f) providing, via a graphical user interface, said administratively filtered news articles to the information client as the customized news feed.

10. The computer-implemented method of claim 9, further comprising the step of:
(g) applying at least one pivot criteria received from the information client to said obtained news articles.

11. The computer-implemented method of claim 9, wherein said plurality of other information clients is selected by accessing a social graph service.

12. The computer-implemented method of claim 9, further comprising the step of:
(g) accessing a client logger executing on a computing device utilized by the information client to collect data related to the reading habits of the information client.

13. A computer program product comprising computer usable medium encoded in a computer having control logic stored therein for causing the computer to provide a customized news feed to an information client, the news feed based on the reading activities and preferences of other information clients within the same organization, said control logic comprising:
first computer readable program code means for causing the computer to collect data related to the reading habits of a plurality of other information clients in the organization;
second computer readable program code means for causing the computer to correlate said data so as to identify a group among said plurality of other information clients having similar reading habits;
third computer readable program code means for causing the computer to identify news source URLs accessed by said group;
fourth computer readable program code means for causing the computer to obtain news articles from said news source URLs;
fifth computer readable program code means for causing the computer to apply an administration filter to said obtained news articles; and
sixth computer readable program code means for causing the computer to provide, via a graphical user interface, said administratively filtered news articles to the information client as the customized news feed.

14. The computer program product of claim 13, further comprising:
seventh computer readable program code means for causing the computer to apply at least one pivot criteria received from the information client to said obtained news articles.

15. The computer program product of claim 13, wherein said plurality of other information clients is selected by accessing a social graph service.

16. A computer-implemented method for facilitating the provisioning of a customized news feed to a user of a computer network, comprising the steps of:
(a) collecting, via a client logger executing on a computing device utilized by the user, information data related to the activities of the user within the computer network;
(b) selecting a plurality of other users of the computer network;
(c) collecting, from at least one source on the computer network, information data related to the activities of each of said plurality of other users of the computer network;
(d) correlating said information data related to the activities of the user and said information data related to the activities of said plurality of other users of the computer network to produce a list of URLs; and
(e) presenting to the user, via a graphical user interface accessible by said computing device utilized by the user, said list of URLs as the customized news feed.

17. The computer-implemented method of claim 16, wherein said at least one source on the computer network is a log file found within at least one of: a web content management server; a document management server; a web server; a proxy server; a directory service information server; and an email server.

18. The computer-implemented method of claim 16, wherein said plurality of other users of the computer network is selected by accessing a social graph service.

19. The computer-implemented method of claim 16, further comprising the step of:
(f) applying at least one pivot criteria received from the user to said list of URLs.

20. The computer-implemented method of claim 16, wherein said information data results from at least of one the user and each of said plurality of other users: navigating to a URL; opening a document; reading an email; and receiving an instant message.
